(19) United States
(12) Patent Application Publication
(10) Pub. No.: US 2007/0201671 A1
(43) Pub. Date: Aug. 30, 2007

(54) User configurable conducted emissions filter

(75) Inventor: Clark Wayne Tollerson, Raleigh, NC (US)

Correspondence Address: FOGG & POWERS LLC, 10 SOUTH FIFTH STREET, SUITE 1000, MINNEAPOLIS, MN, 55402, US

(73) Assignee: ADC DSL Systems, Inc., Eden Prairie, MN (US)

(21) Appl. No.: 11/363,974

(22) Filed: Feb. 27, 2006

(51) Int. Cl. H04M 3/00; H04M 5/00

(52) U.S. Cl. 379/242

(57) ABSTRACT

A conducted emissions filter is disclosed. The filter includes a main supply port adapted to provide a power signal to a power supply port, along with a common mode choke coupled between the main supply port and the power supply port with at least one adjustable level of inductance for substantially matching a level of impedance introduced through the power supply port without adversely impacting operation of the filter. The filter further includes at least one filter attenuation element connected across return and supply lines between the at least one common mode choke and the power supply port, at least one return line noise return connected to the return line between the at least one filter attenuation element and the power supply port, and at least one supply line noise return connected to the supply line between the at least one filter attenuation element and the power supply port.

### BACKGROUND

Telecommunications networks transport signals between equipment at diverse locations. Telecommunications networks include a number of components. For example, a telecommunications network typically includes a number of switching elements that provide selective routing of signals between network elements. Additionally, telecommunications networks include communication media, e.g., twisted pair, fiber optic cable, coaxial cable or the like that transport the signals between switches. Further, some telecommunications networks include access networks.

For purposes of this specification, the term “access network” means a portion of a telecommunications network, e.g., the public switched telephone network (PSTN), which allows subscriber equipment or devices to connect to a core network. At the core network side, a central office is provided. The central office is connected to the remote terminal over a high-speed digital link, e.g., a number of T1 lines or other appropriate high-speed digital transport medium. A remote terminal has line cards and other electronic circuits that need power to operate properly.

In some applications, the remote terminal is powered locally. In some situations, to reduce demands on a central office power plant, a local battery plant is typically used to power the remote terminal. The local battery plant adds cost and complicates the maintainability of the remote terminal. In particular, operational requirements for the local battery plant will stipulate operation over extended temperature ranges. In other applications, the remote terminal is fed power over a line from the central office. This is referred to as line feeding (line powering) and is accomplished over digital subscriber line (DSL) pairs, or other communication medium, from a central office network element card. When local power is available at a remote location, the remote terminal is powered from a local battery source, e.g., −48 VDC. An option of whether to power the remote terminal from the central office or from the local battery source is typically controlled by user configurable jumpers on a remote terminal network card.

All electrical circuits generate unintentional noise which has the potential to leak back into the power source. The level of this noise is known as conducted emissions. A common mitigation for conducted emissions is a power supply filter that blocks higher frequency components which are generated by the circuit from passing back onto the power distribution network. When the remote terminal is powered by the local battery source, there are set requirements on the amount of energy that can be returned into the local battery source network. When the remote terminal is line powered, the central office is the source of the power, and therefore only the central office must meet conducted emissions requirements into a central office battery source. Although there are no requirements for conducted emissions at the remote terminal, minimal amounts of electrical noise are allowed back into the communication medium. Conducted emissions are also a concern in other types of electronic circuits.

Ideally, a common power supply filter would solve conducted emissions for all products. However, different products have different power needs and generate different noise profiles. These results in a custom filter being designed for every product.

### SUMMARY

The above mentioned problems with reducing conducted emissions in an electronic circuit and other problems are addressed by embodiments of the present invention and will be understood by reading and studying the following specification. Particularly, in one embodiment, a conducted emissions filter is provided. The filter includes a main supply port adapted to provide a power signal to a power supply port, along with a common mode choke coupled between the main supply port and the power supply port with at least one adjustable level of inductance for substantially matching a level of impedance introduced through the power supply port without adversely impacting operation of the filter. The filter further includes at least one filter attenuation element connected across return and supply lines between the at least one common mode choke and the power supply port, at least one return line noise return connected to the return line between the at least one filter attenuation element and the power supply port, and at least one supply line noise return connected to the supply line between the at least one filter attenuation element and the power supply port.

### DRAWINGS

FIG. 1 is a block diagram of an embodiment of a system encompassing a conducted emissions filter in accordance with the present invention;

FIG. 2 is a block diagram of another embodiment of a system encompassing a conducted emissions filter in accordance with the present invention;

FIG. 3 is a schematic diagram of an embodiment of a conducted emissions filter in accordance with the present invention;

FIG. 4 is a flow diagram illustrating an embodiment of a method for configuring a user-selectable conducted emissions filter in accordance with the present invention; and

FIG. 5 is a flow diagram illustrating another embodiment of a method for configuring a user-selectable conducted emissions filter in accordance with the present invention; and

FIG. 6 is a flow diagram illustrating an embodiment of a method for reducing conducted emissions in an electronic circuit in accordance with the present invention.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical, and electrical changes may be made without departing from the spirit and scope of the present invention. The following detailed description is, therefore, not to be taken in a limiting sense.

Embodiments of the present invention address problems with reducing conducted emissions in a telecommunications network element and will be understood by reading and studying the following specification. Particularly, in one embodiment, a conducted emissions filter is provided. The filter includes a main supply port adapted to provide a power signal to a power supply port, along with a common mode choke coupled between the main supply port and the power supply port with at least one adjustable level of inductance for substantially matching a level of impedance introduced through the power supply port without adversely impacting operation of the filter. The filter further includes at least one filter attenuation element connected across return and supply lines between the at least one common mode choke and the power supply port, at least one return line noise return connected to the return line between the at least one filter attenuation element and the power supply port, and at least one supply line noise return connected to the supply line between the at least one filter attenuation element and the power supply port.

Although one or more embodiments in this description are described in terms of telecommunications networks, embodiments of the present invention are not limited to applications of telecommunications networks. Embodiments of the present invention are applicable to any power conditioning activity that requires the use of conducted emissions filtering. Alternate embodiments of the present invention to those described below include a user-selectable conducted emissions filter for electronic circuits that provides power supply impedance matching without modifying the intended operation of the filter.

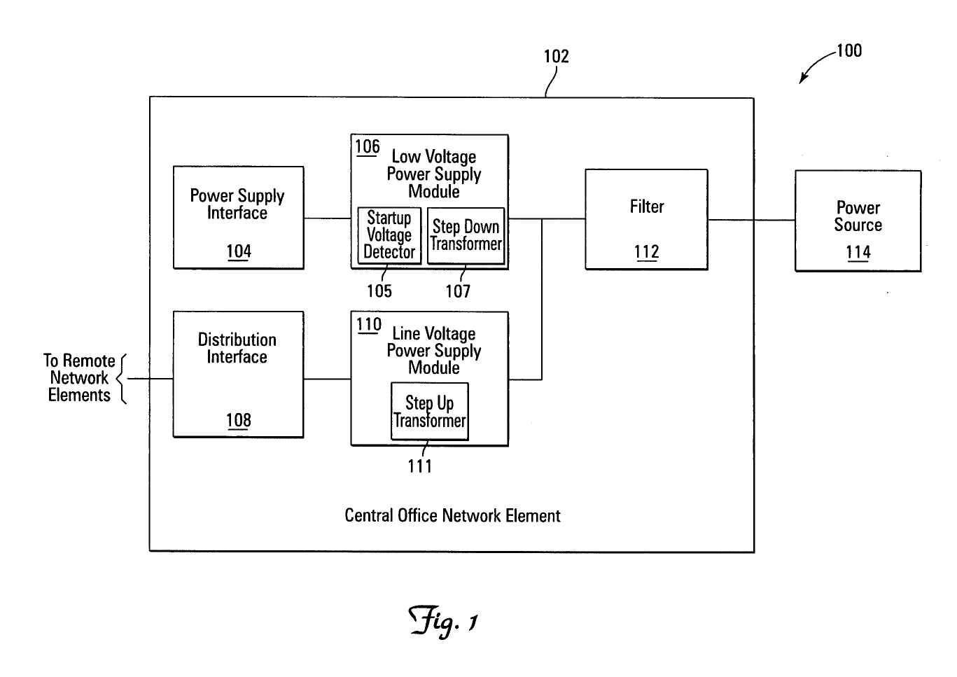

FIG. 1 is a block diagram of an embodiment of a system, indicated generally at 100, encompassing a conducted emissions filter according to the teachings of the present invention. System 100 comprises central office network element 102 and power source 114. In one embodiment, power source 114 provides power for one or more central office network elements in system 100. In one embodiment, power source 114 provides a −48 VDC battery-powered signal to central office network element 102. Central office network element 102 further comprises power supply interface 104, distribution interface 108, low voltage power supply module 106, line voltage power supply module 110, and filter 112. Each component of system 100 is discussed in detail below. It is noted that for simplicity in description, a single power supply interface 104 and a single low voltage power supply module 106 are shown in FIG. 1. However, it is understood that central office network element 102 is capable of accommodating any appropriate number of power supply interfaces 104 and low voltage power supply modules 106, e.g., at least one power supply interface and at least one low voltage power supply module in a single central office network element 102.

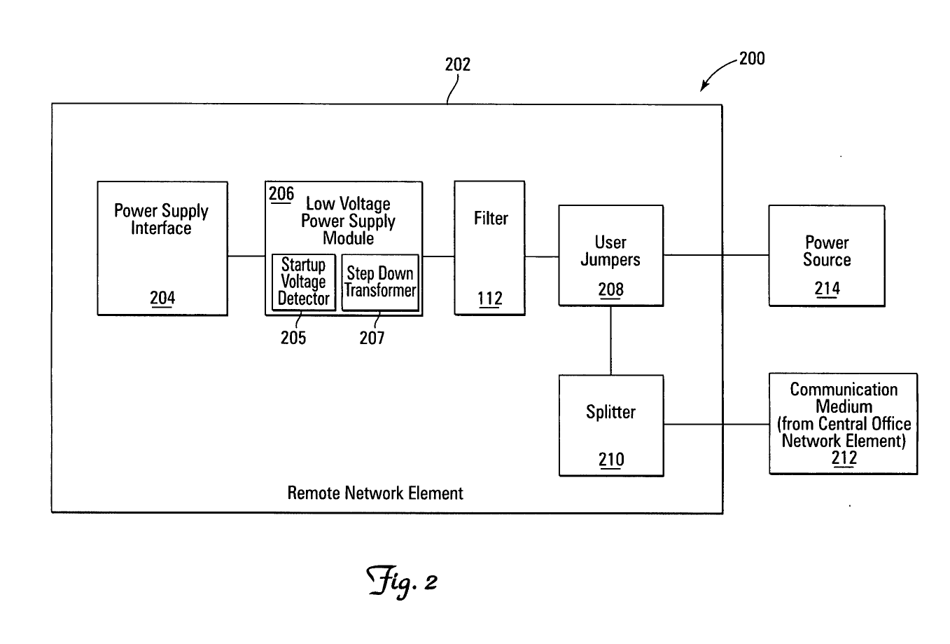

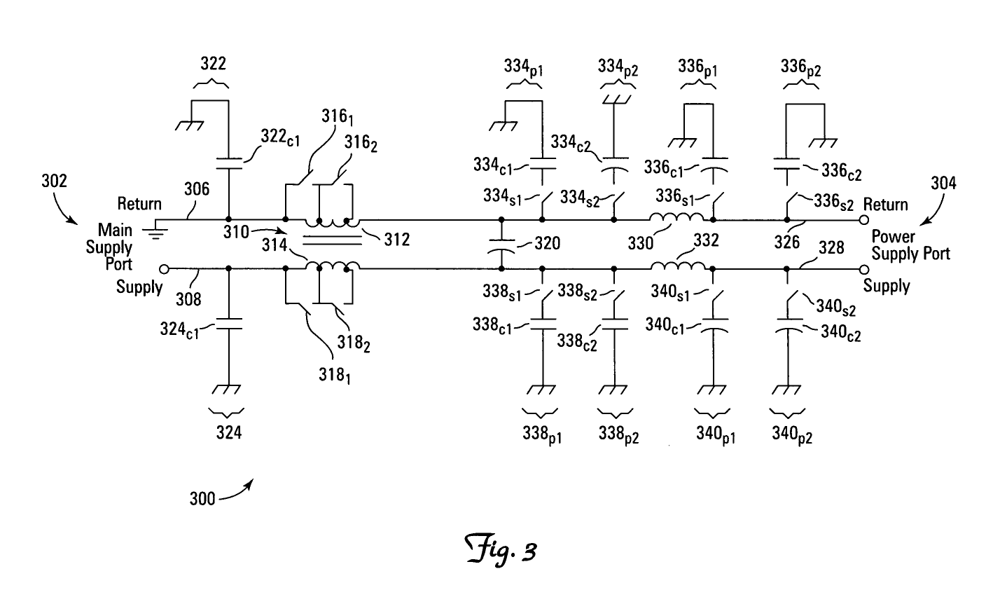

Filter 112 includes appropriate components for limiting conducted emissions from the at least one low voltage power supply module 106 and line voltage power supply module 110. In one embodiment, filter 112, the at least one low voltage power supply module 106, and line voltage power supply module 110 are fabricated on a printed wiring board assembly (PWBA) mounted within central office network element 102. The components that comprise filter 112 are discussed in further detail below with respect to FIG. 3. The at least one low voltage power supply module 106 is a switching power supply that provides low voltage DC power signals to central office network element 102. Each of the at least one low voltage power supply module 106 includes startup voltage detector circuit 105 and step-down transformer 107. Line voltage power supply module 110 is a switching power supply that provides line voltage power signals to distribution interface 108 for line powering one or more communication devices. The one or more communication devices include a remote terminal in a digital loop carrier, a DSL modem, an integrated access device, or other appropriate network elements. Line voltage power supply module 110 includes step-up transformer 111. Distribution interface 108 is a combiner that sends line power signals over one or more DSL pairs, or other communication medium, to one or more remote network elements as described with respect to FIG. 2 below.

In operation, power source 114 provides local power, e.g., −48 VDC, to central office network element 102. Startup voltage detector circuit 105 detects an input power level provided by power source 114 and passed through filter 112. In one embodiment, step-down transformer 107 converts −48 VDC local power provided by power source 114 to 5 VDC, 3.3 VDC, or any suitable low voltage DC power signal value. Moreover, step-up transformer 111 converts −48 VDC local power provided by power source 114 to +/−100 VDC, 0 and −125 V DC, 0 and −185 VDC, or any suitable line power signal value. Filter 112 ensures that substantial amounts of conducted emissions are not passed back into power source 110 from either the at least one low voltage power supply module 106 or line voltage power supply module 110. Since either of the at least one low voltage power supply module 106 and line voltage power supply module 110 is configured to supply varying magnitudes of local or line power signal values, filter 112 is constructed to provide a selectable range of conducted emissions control over a frequency spectrum. In one embodiment, the frequency spectrum is from 10 kHz to 30 MHz. In another embodiment, the frequency spectrum is from 150 kHz to 30 MHz. Further, filter 112 is modifiable to control the level of conducted emissions without adversely impacting its filtering operation.

FIG. 2 is a block diagram of another embodiment of a system, indicated generally at 200, encompassing a conducted emissions filter according to the teachings of the present invention. System 200 comprises remote network element 202, communication medium 212, and power source 214. In one embodiment, power source 214 provides a −48 VDC battery-powered signal to remote network element 202. In another embodiment, communication medium 212 provides line power from a central office network element, similar to central office network element 102 described above with respect to FIG. 1. Remote network element 202 further comprises power supply interface 204, low voltage power supply module 206, filter 112, user jumpers 208, and splitter 210. Each component of network 200 is discussed in detail below. It is noted that for simplicity in description, a single power supply interface 204 and a single low voltage power supply module 206 are shown in FIG. 2. However, it is understood that remote network element 202 is capable of accommodating any appropriate number of power supply interfaces 204 and low voltage power supply modules 206, e.g., at least one power supply interface and at least one low voltage power supply module in a single remote network element 202.

In one embodiment, filter 112 is the same filter described with respect to FIG. 1 above. Again, filter 112 includes appropriate components for limiting conducted emissions from the at least one low voltage power supply module 206. The components that comprise filter 112 are discussed in further detail below with respect to FIG. 3. User jumpers 208 couple filter 112 with power source 214 or splitter 210, depending on a jumper configuration. The at least one low voltage power supply module 206 includes at least one startup voltage detector circuit 205 and at least one step-down transformer 207. In one embodiment, splitter 210 separates DSL signals, or the like, from communication medium 212.

In operation, user jumpers 208 is configured for the at least one low voltage power supply module 206 to receive local battery power from power source 214. Startup voltage detector circuit 205 detects a local battery power level provided by power source 214 and passed through filter 112.

In one embodiment, step-down transformer 207 converts −48 VDC local power provided by power source 214 to 5 VDC, 3.3 VDC, or any suitable low voltage power signal value. In another embodiment, user jumpers 208 is configured for the at least one low voltage power supply module 206 to receive line power from communication medium 212. Startup voltage detector circuit 205 detects a line power DC voltage level provided by communication medium 212 and passed through splitter 210 and filter 112. Step-down transformer 207 converts the line power DC voltage level provided by communication medium 212 to 5 VDC, 3.3 VDC, or any suitable low voltage power signal value. In one embodiment, the line power DC voltage level is from −125 VDC to −200 VDC. Filter 112 limits substantial amounts of conducted emissions from passing back into power source 214 or communication medium 212 (depending on the jumper configuration at user jumpers 208) from the at least one low voltage power supply module 206. Since the at least one low voltage power supply module 206 is configured to supply varying magnitudes of power signal values, filter 112 is constructed to provide a selectable range of conducted emissions control over a frequency spectrum. In one embodiment, the frequency spectrum is from 10 kHz to 30 MHz. In another embodiment, the frequency spectrum is from 150 kHz to 30 MHz. Further, filter 112 is modifiable to control the level of conducted emissions without adversely impacting its filtering operation.

FIG. 3 is a schematic diagram of one embodiment of a conducted emissions filter, indicated generally at 300, according to the teachings of the present invention. Filter 300 is configured to provide a variable level of conducted emissions protection depending on an amount of power signal injected into a telecommunication network element. In one embodiment, the telecommunication network element is network element 102 described above with respect to FIG. 1. In a similar embodiment, the telecommunication network element is network element 202 described above with respect to FIG. 2.

Filter 300 includes two interface ports: main supply port 302 and power supply port 304. In one embodiment, main supply port 302 is adapted to be coupled to a power source for providing power to a telecommunications network element, similar to the network elements described above with respect to FIGS. 1 and 2. Moreover, power supply port 304 is adapted to be coupled to a power supply module providing an appropriate amount of DC line or battery power to the telecommunications network element, similar to the network element described above with respect to FIGS. 1 and 2.

Main supply port 302 is adapted to provide a power signal to power supply port 304. In one embodiment, main supply port 302 includes main return line 306 and main supply line 308. Main return line 306 and main supply line 308 are adapted to be coupled to positive and negative terminals, respectively, of a power source (not shown). The power signal at main return line 306 is provided to return line 326 on power supply port 304. Similarly, the power signal at main supply line 308 is provided to supply line 328 on power supply port 304. The power signals provided to return and supply lines 326 and 328, respectively, are filtered to limit conducted emissions to the power source from the network element.

In one embodiment, filter 300 includes a number of components coupled between main supply port 302 and power supply port 304 to provide conducted emissions filtering: main return overload path 322, coupled to main return line 306; main supply overload path 324, coupled to main supply line 308; adjustable coupled inductor 310; filter attenuation element 320, connected across return line 326 and supply line 328; filter return inductor 330, incorporated within return line 326 between filter attenuation element 320 and power supply port 304; and filter supply inductor 332, incorporated within supply line 328 between filter attenuation element 320 and power supply port 304. Main return overload path 322 and main supply overload path 324 each contain a capacitor 322_{C1} and 324_{C1}, respectively, to prevent any stray DC noise levels from overloading the input of main supply port 302. Adjustable coupled inductor 310 includes first winding 312 and second winding 314 that are wrapped around a common core to provide an adjustable mutual inductance. By using the common core, first winding 312 and second winding 314 is well matched. Adjustable coupled inductor 310 is referred to as a common mode choke. Adjustable coupled inductor 310 blocks common mode currents without affecting differential mode currents.

Adjustable coupled inductor 310 further includes return inductance selector switch 316₁ to 316₂ and supply inductance selector switch 318₁ to 318₂. It is noted that in this description, a total of two return inductance selector switches 316₁ to 316₂ and two supply inductance selector switches 318₁ to 318₂ are shown in FIG. 3. However, it is understood that coupled inductor 310 supports any appropriate number of selector switches, e.g., one or more selector switches on a single inductor coil. In one embodiment, return inductance selector switch 316₁ to 316₂ and supply inductance selector switch 318₁ to 318₂ are each a fuse that is permanently opened by applying a value of current that permanently opens the fuse. In another embodiment, return inductance selector switch 316₁ to 316₂ and supply inductance selector switch 318₁ to 318₂ are a series of jumpers that are manipulated manually. In still another embodiment, return inductance selector switch 316₁ to 316₂ and supply inductance selector switch 318₁ to 318₂ are solid-state switches that are controlled by software machine-coded instructions. The use of inductance selector switches 316₁ to 316₂ and 318₁ to 318₂ with adjustable coupled inductor 310 provides a user-selectable conducted emissions filter for the power signals passing from main return line 306 to return line 326 and main supply line 308 to supply line 328.

In one embodiment, filter attenuation element 320 is a capacitor used in conjunction with coupled inductor 310 to divert differential mode currents. The filter return inductor 330 and filter supply inductor 332 are used to block external electrical noise from flowing into power supply port 304 along return line 326 and supply line 328 on power supply port 304, respectively. In one embodiment, filter return inductor 330 and filter supply inductor 332 are matching inductors.

To divert common mode current, a series of return paths are included on either side of filter return inductor 330 and filter supply inductor 332. Main return line noise paths 334_{P1} and 334_{P2} and internal return line noise paths 336_{P1} and 336_{P2} are included on the main and internal sides of filter return inductor 330, respectively. Main return line noise paths 334_{P1} and 334_{P2} further comprise capacitors 334_{C1} and 334_{C2} and switches 334_{S1} and 334_{S2}. Switches 334_{S1} and 334_{S2} engage or disengage any of main return line noise paths 334_{P1} and 334_{P2}. Internal return line noise paths 336_{P1} and 336_{P2} further comprise capacitors 336_{C1} and 336_{C2} and switches 336_{S1} and 336_{S2}. Switches 336_{S1} and 336_{S2} engage or disengage any of main return line noise paths 336_{P1} and 336_{P2}. Main supply line noise paths 338_{P1} and 338_{P2} and internal supply line noise paths 340_{P1} and 340_{P2} are included on the main and internal sides of filter supply inductor 332, respectively. Main supply line noise paths 338_{P1} and 338_{P2} further comprise capacitors 338_{C1} and 338_{C2} and switches 338_{S1} and 338_{S2}. Switches 338_{S1} and 338_{S2} engage or disengage any of main supply line noise paths 338_{P1} and 338_{P2}. Internal supply line noise paths 340_{P1} and 340_{P2} further comprise capacitors 340_{C1} and 340_{C2} and switches 340_{S1} and 340_{S2}. Switches 340_{S1} and 340_{S2} engage or disengage any of main supply line noise paths 340_{P1} and 340_{P2}.

It is noted that in this description, a total of two main return line noise paths 334_{P1} and 334_{P2}, two internal return line noise paths 336_{P1} and 336_{P2}, two main supply line noise paths 338ₚ, and 338_{P2}, and two internal supply line noise paths 340_{P1} and 340_{P2} are shown in FIG. 2. However, it is understood that filter return inductor 330 and filter supply inductor 332 support any appropriate number of line noise paths, e.g., one or more paths on either side of filter return inductor 330 and filter supply inductor 332.

In one embodiment, switches 334_{S1}, 334_{S2}, 336_{S1}, 336_{S2}, 338_{S1}, 338_{S2}, 340_{S1} and 340_{S2} are each a fuse that is permanently opened by applying a value of current that permanently opens the fuse, e.g., an anti-fuse. In another embodiment, switches 334_{S1}, 334_{S2}, 336_{S1}, 336_{S2}, 338_{S1}, 338_{S2}, 340_{S1} and 340_{S2} are each a removable jumper that can be manipulated manually. In still another embodiment, switches 334_{S1}, 334_{S2}, 336_{S1}, 336_{S2}, 338_{S1}, 338_{S2}, 340_{S1} and 340_{S2} are each a solid-state switch that is controlled by software machine-coded instructions. The engaging or disengaging of any of paths 334, 336, 338 and 340 operate in conjunction with return inductance selector switches 316₁ to 316₂ and supply inductance selector switches 318₁ to 318₂ to adjust the amount of conducted emissions filtering required in filter 300.

In operation, filter 300 injects power signals from main supply port 302 onto an input line at power supply port 304 without substantial conducted emissions sent back into main supply port 302. Filter 300 is adjusted to substantially match a first level of impedance as seen from power supply port 304 with a second level of impedance as seen from main supply port 302. Sufficient matching of the first and second impedance levels is accomplished by a combination of adjustable coupled inductor 310 and return and supply line noise paths 334 to 340 as discussed above. Filter 300 is designed to accommodate one or more commercial off the shelf (COTS) power supply module with one or more acceptable input and output levels. The one or more commercial off the shelf (COTS) power supply modules are required to meet selection criteria for use in either of network element 102 of FIG. 1 or network element 202 of FIG. 2. This selection criteria involves meeting conducted emissions requirements within a conducted emissions bandwidth. In one embodiment, the conducted emissions bandwidth comprises a frequency spectrum from 10 kHz to 30 MHz. In a similar embodiment, the conducted emissions bandwidth comprises a frequency spectrum from 150 kHz to 30 MHz. Substantially matching the first level of impedance with the second level of impedance sufficiently reduces the conducted emissions from network elements 102 or 202 and does not require deviation from the intended operation of filter 300. Further, the impedance matching provided by filter 300 substantially reduces noise within the conducted emissions bandwidth without inducing oscillations into the one or more COTS power supply modules used in network elements 102 and 202.

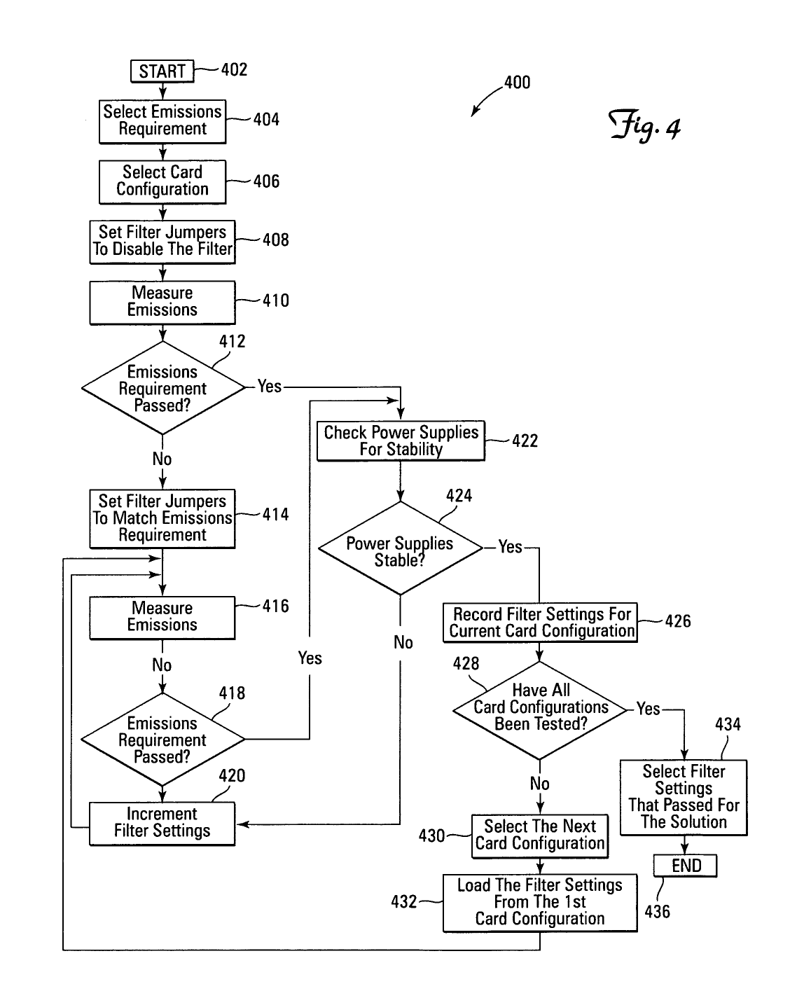

FIG. 4 is a flow diagram illustrating an embodiment of a method 400 according to the teachings of the present invention for configuring a user-selectable conducted emissions filter. Method 400 begins at block 402. In an example embodiment, method 400 ensures that substantial amounts of conducted emissions from element 102 are not passed back into one or more power sources without adversely impacting operation of filter 300 or inducing oscillations into low voltage power supply module 106 and line voltage power supply module 110.

At block 404, a conducted emissions requirement to be tested is selected, e.g., 150 kHz for a 150 kHz to 30 MHz conducted emissions filtering requirement. Next, a particular configuration for element 102 is selected at block 406. In one embodiment, the particular configuration is adapted for a maximum power condition. At block 408, filter 300 is disabled for an initial test to determine how filter 300 will need to be set to meet the conducted emissions requirement. At block 410, a first conducted emissions measurement is made. Filter 300 will remain disabled if the first conducted emissions measurements indicate conducted emissions requirements are sufficiently met at block 412, e.g. element 102 sufficiently meets acceptable criteria for conducted emissions within a conducted emissions bandwidth. In one embodiment, the conducted emissions bandwidth comprises a frequency spectrum from 10 kHz to 30 MHz. In a similar embodiment, the conducted emissions bandwidth comprises a frequency spectrum from 150 kHz to 30 MHz. If the conducted emissions requirements are sufficiently met, method 400 continues at step 422

If the conducted emissions requirements are not sufficiently met, the method proceeds to block 414. Filter 300 is configured for an initial set of filter settings at block 414 intended for element 102 to meet the conducted emissions requirement. At block 416, a second conducted emissions measurement is made. If the second conducted emissions measurement indicates conducted emissions requirements are sufficiently met, e.g., element 102 sufficiently meets acceptable criteria for conducted emissions within the conducted emissions bandwidth (as discussed above), the initial set of filter settings are acceptable and method 400 proceeds to block 422. If the initial set of filter settings is not sufficient, the filter settings for filter 300 are adjusted at block 420. In one embodiment, at least one subsequent filter setting made at block 420 is set to attenuate at least one specific frequency area that fails. Method 400 returns to block 416 for a subsequent conducted emissions measurement.

At block 422, low voltage power supply module 106 and line voltage power supply module 110 are measured for power supply stability. In an example embodiment, the initial set of filter settings for filter 300 attempt to substantially match the impedance levels between low voltage power supply module 106, line voltage power supply module 110, and power source 114 in order to provide power supply stability for both low voltage power supply module 106 and line voltage power supply module 110. A target matching impedance level is substantially equivalent to a 50Ω LISN (Line Impedance Stabilizer Network). If both low voltage power supply module 106 and line voltage power supply module 110 are determined to be stable at block 424, a current set of filter settings for filter 300, for the particular configuration of element 102, is recorded at block 426. If it is determined that one of low voltage power supply module 106 and line voltage power supply module 110 are not stable, method 400 returns to block 420.

Once block 428 determines that all applicable card configurations for element 102 have been tested, method 400 selects the filter settings for filter 300 that passed at block 434. Otherwise, a next configuration for element 102 is selected for testing at block 430. At block 432, the filter settings from the previous configuration are used as a starting point before returning to block 416. It is understood that method 400 is repeated for additional, e.g., one or more, configurations to measure conducted emissions over at least one frequency spectrum.

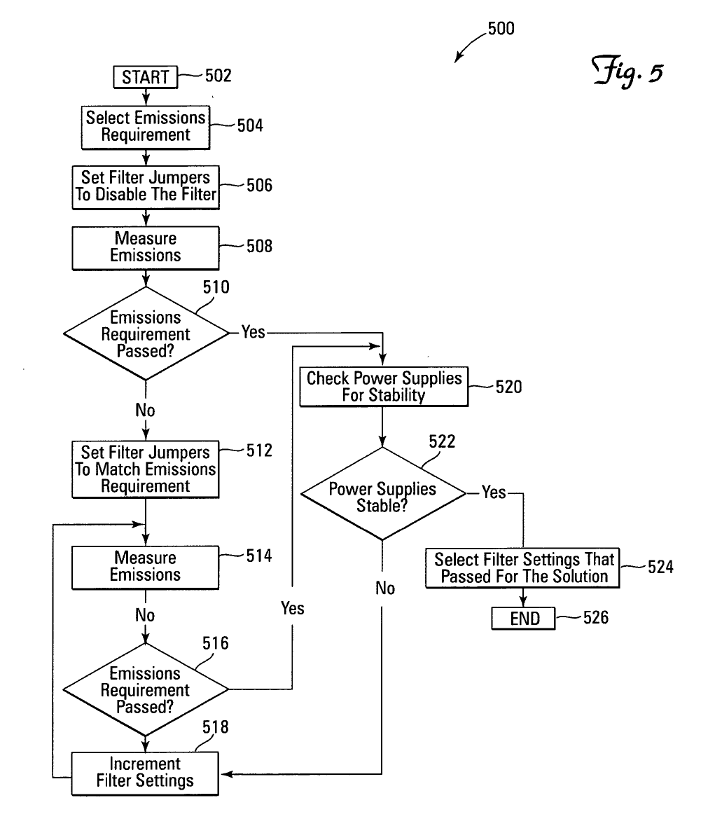

FIG. 5 is a flow diagram illustrating another embodiment of a method 500 according to the teachings of the present invention for configuring a user-selectable conducted emissions filter. Method 500 begins at block 502. In an example embodiment, method 500 ensures that substantial amounts of conducted emissions from element 102 are not passed back into one or more power sources without adversely impacting operation of filter 300 or inducing oscillations into low voltage power supply module 106 and line voltage power supply module 110.

At block 504, a conducted emissions requirement to be tested is selected, e.g., 150 kHz for a 150 kHz to 30 MHz conducted emissions filtering requirement. Next, filter 300 is disabled at block 506 for an initial test to determine how filter 300 will need to be set to meet the conducted emissions requirement. At block 508, a first conducted emissions measurement is made. If the first conducted emissions measurements indicate conducted emissions requirements are sufficiently met at block 510, e.g., element 102 sufficiently meets acceptable criteria for conducted emissions within a conducted emissions bandwidth (as discussed above with respect to FIG. 4), filter 300 will remain disabled, and the method proceeds to block 520. If the conducted emissions requirements are not sufficiently met, the method proceeds to block 512. Filter 300 is configured for an initial set of filter settings at block 512 intended for element 102 to meet the conducted emissions requirement. At block 514, a second conducted emissions measurement is made. If the second conducted emissions measurement indicates conducted emissions requirements are sufficiently met at block 516, e.g., element 102 sufficiently meets acceptable criteria for conducted emissions within the conducted emissions bandwidth (as discussed above with respect to FIG. 4), the initial set of filter settings are acceptable and method 500 proceeds to block 520. If the initial set of filter settings is not sufficient, the filter settings for filter 300 are adjusted at block 518. In one embodiment, at least one subsequent filter setting made at block 518 is set to attenuate at least one specific frequency area that fails. Method 500 returns to block 514 for a subsequent conducted emissions measurement.

At block 520, low voltage power supply module 106 and line voltage power supply module 110 are measured for power supply stability. Similar to method 400, the initial set of filter settings for filter 300 attempt to substantially match the impedance levels between low voltage power supply module 106, line voltage power supply module 110, and power source 114 in order to provide power supply stability for both low voltage power supply module 106 and line voltage power supply module 110. If both low voltage power supply module 106 and line voltage power supply module 110 are determined to be stable at block 522, a current set of filter settings for filter 300 are recorded at block 524. If it is determined that one of low voltage power supply module 106 and line voltage power supply module 110 are not stable, method 500 returns to block 518.

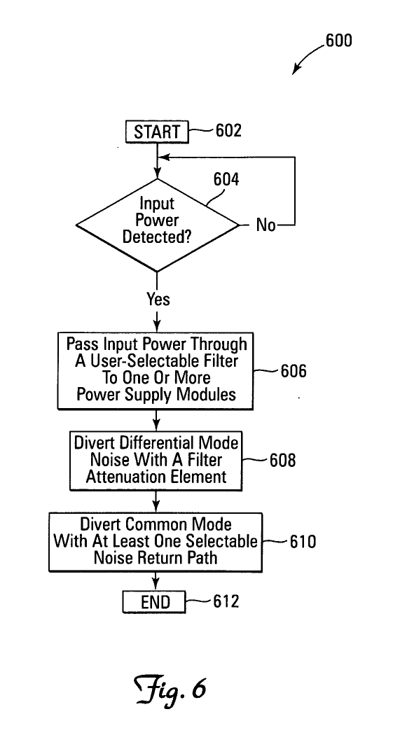

FIG. 6 is a flow diagram illustrating an embodiment of method 600 according to the teachings of the present invention for reducing conducted emissions in an electronic circuit. Method 600 begins at block 602. In an example embodiment, method 600 ensures that before a power signal is provided to network elements 102 and 202, the power signal is passed through a filter 300 to substantially reduce amounts of conducted emissions from network elements 102 and 202 in order to sufficiently meet conducted emissions requirements.

Method 600 determines whether input power is detected at block 604. If input power is detected, input power passes through filter 300 to one or more power supply modules at block 606. If input power is not detected, block 604 is repeated. At block 608, filter attenuation element 320 diverts differential mode noise from filter 300. At block 610, at least one of selectable noise return paths 334, 336, 338, and 340 divert common mode noise from filter 300 before method 600 concludes at block 612.

The description of the present invention has been presented for purposes of illustration and description, and is not intended to be exhaustive or limited to the invention in the form disclosed. Variations and modifications may occur, which fall within the scope of the present invention, as set forth in the following claims.

What is claimed is:

1. A conducted emissions filter, comprising:
a main supply port adapted to provide a power signal to a power supply port;
a common mode choke coupled between the main supply port and the power supply port with at least one adjustable level of inductance for substantially matching a level of impedance introduced through the power supply port without adversely impacting operation of the filter;
at least one filter attenuation element connected across return and supply lines between the at least one common mode choke and the power supply port;
at least one return line noise return connected to the return line between the at least one filter attenuation element and the power supply port; and
at least one supply line noise return connected to the supply line between the at least one filter attenuation element and the power supply port.

2. The filter of claim 1, wherein the main supply port receives a power signal selected from one of a battery source and a DC line source.

3. The filter of claim 1, wherein the power supply port provides a power signal to at least one switching power supply.

4. The filter of claim 1, wherein the at least one common mode choke with at least one adjustable level of inductance further comprises adjusting the at least one level of inductance with one of an anti-fuse, a series of removable jumpers, and solid-state switches under software control.

5. The filter of claim 1, wherein the at least one filter attenuation element further comprises the use of at least one capacitor in conjunction with the at least one common mode choke to divert differential mode currents.

6. The filter of claim 1, wherein the at least one return line noise return and the at least one supply line noise return further comprise selecting one of at least one capacitor with at least one anti-fuse, at least one removable jumper, and at least one solid-state switch under software control.

7. A circuit for limiting conducted emissions, the circuit comprising:
means for selecting a sufficient level of conducted emissions control without adversely impacting operation of the circuit;
means for establishing, responsive to the means for selecting, a substantially matching level of impedance between the circuit and at least one switching power supply; and
means for passing, responsive to the means for establishing, a power signal from one or more power sources to the at least one switching power supply.

8. The circuit of claim 7, wherein the means for selecting a sufficient level of conducted emissions control comprises a user-selectable conducted emissions filter including:
a common mode choke with an adjustable mutual inductance;
at least one noise return path; and
a filter attenuation element coupled between the common mode choke and the at least one noise return path.

9. The circuit of claim 7, wherein the means for establishing the substantially matching level of impedance includes a user-selectable conducted emissions filter coupled between one or more power sources and the at least one switching power supply.

10. The circuit of claim 7, wherein the means for passing the power signal from one or more power sources to the at least one switching power supply includes one of user jumpers and a direct connection.

11. A central office network element, comprising:
a power supply interface coupled to at least one low voltage power supply module;
a distribution interface coupled to a line voltage power supply module;
a filter with at least one adjustable level of inductance coupled to a power source and between the at least one low voltage power supply module and the line voltage power supply module; and
wherein the filter substantially matches a first level of impedance introduced by the at least one low voltage power supply module and the line voltage power supply module with a second level of impedance introduced by the power source.

12. The central office network element of claim 11, wherein the at least one low voltage power supply module and the filter are fabricated on a printed wiring board assembly mounted within the central office network element.

13. The central office network element of claim 11, wherein the power source is a battery source.

14. The central office network element of claim 11, wherein the at least one low voltage power supply module further comprises:
a startup voltage detector that detects a power signal provided by the power source; and
a step-down transformer that converts the power signal to a low voltage DC power signal.

15. The central office network element of claim 11, wherein the line voltage power supply module further comprises a step-up transformer that converts the power signal to a line power signal for powering one or more communication devices.

16. The central office network element of claim 11, wherein the distribution interface further comprises a combiner that sends line power signals to one or more communications devices.

17. A remote network element, comprising:
a power supply interface coupled to one or more low voltage power supply modules;
a filter with at least one adjustable level of inductance;
user jumpers configured to couple the filter between the one or more low voltage power supply modules and one or more power sources; and
wherein the filter substantially matches a first level of impedance introduced by the one or more low voltage power supply modules with a second level of impedance introduced by the one or more power sources.

18. The remote network element of claim 17, further comprising one of a remote terminal in a digital loop carrier, a digital subscriber line modem, an integrated access device, or other telecommunications network element.

19. The remote network element of claim 17, wherein the one or more low voltage power supply modules and the filter are fabricated on a printed wiring board assembly mounted within the remote network element.

20. The remote network element of claim 17, wherein the one or more power sources is one of a battery source and a DC line voltage.

21. The remote network element of claim 20, wherein the DC line voltage is coupled through a splitter to separate communication signals from line power signals.

22. The remote network element of claim 17, wherein each of the one or more low voltage power supply modules further comprise:
a startup voltage detector that detects a power signal provided by the power source; and
a step-down transformer that converts the power signal to a low voltage DC power signal.

23. A method for reducing conducted emissions in an electronic circuit, the method comprising:
detecting an input power signal from one or more power sources;
passing the input power signal to at least one power supply module through a user-selectable filter; and
without adversely impacting operations of the user-selectable filter or inducing oscillations into the at least one power supply module, ensuring that substantial amounts of the conducted emissions in the electronic circuit are not passed back into the power source from the at least one power supply module over a frequency spectrum.

24. The method of claim 23, wherein the electronic circuit comprises one of a digital loop carrier, a digital subscriber line modem, an integrated access device, or other telecommunications network element.

25. The method of claim 23, wherein the one or more power sources include one of a battery source and a DC line voltage.

26. The method of claim 23, wherein the user-selectable filter further comprises a common mode choke with an adjustable mutual inductance.

27. The method of claim 23, wherein the at least one power supply module is a switching power supply module that converts the power signal to a suitable input value.

28. The method of claim 23, wherein ensuring that the substantial amounts of the conducted emissions in the electronic circuit are not passed back into the power source further comprises:
diverting differential mode noise with a filter attenuation element contained in the user-selectable filter; and
diverting common mode noise with at least one user-selectable noise return path contained in the user-selectable filter.

29. A method for configuring a user-selectable conducted emissions filter, the method comprising:
selecting at least one conducted emissions requirement;
selecting at least one card configuration; and
adjusting the user-selectable conducted emissions filter to substantially match a first impedance level as seen from at least one variety of power supply modules with a second impedance level as seen from a main power supply over a frequency spectrum without adversely impacting operation of the filter or inducing oscillations into the at least one variety of power supply modules.

30. The method of claim 29, wherein selecting the at least one conducted emissions requirement comprises disabling the user-selectable filter to determine how the filter will need to be set to meet the at least one conducted emissions requirement.

31. The method of claim 29, wherein selecting the at least one card configuration further comprises loading a current set of user-selectable filter settings from a first card configuration for at least a second card configuration.

32. The method of claim 29, wherein adjusting the user-selectable conducted emissions filter further comprises setting the user-selectable filter to attenuate at least one specific frequency area within the frequency spectrum.

33. A method for configuring a user-selectable conducted emissions filter, the method comprising:
selecting at least one conducted emissions requirement; and
adjusting the user-selectable conducted emissions filter to substantially match a first impedance level as seen from at least one variety of power supply modules with a second impedance level as seen from a main power supply over a frequency spectrum without adversely impacting operation of the filter or inducing oscillations into the at least one variety of power supply modules.

34. The method of claim 33, wherein selecting the at least one conducted emissions requirement comprises disabling the user-selectable filter to determine how the filter will need to be set to meet the at least one conducted emissions requirement.

35. The method of claim 33, wherein adjusting the user-selectable conducted emissions filter further comprises setting the user-selectable filter to attenuate at least one specific frequency area within the frequency spectrum.

36. A telecommunications network, comprising:
one or more network elements with a user-selectable filter coupled to at least one power source;
at least one distribution interface linking the one or more network elements; and
wherein the user-selectable filter includes at least one adjustable level of inductance to substantially match a first level of impedance introduced by at least one switching power supply within each of the one or more network elements with a second level of impedance as seen from the at least one power source over a conducted emissions bandwidth.

37. The network of claim 36, wherein the at least one power source comprises one of a battery source and a DC line voltage.

38. The network of claim 36, wherein the at least one distribution interface comprises DSL pairs.
